(19) United States
(12) Patent Application Publication
(10) Pub. No.: US 2014/0238338 A1
(43) Pub. Date: Aug. 28, 2014

(54) VARIABLE COMPRESSION ENGINE

(71) Applicant: Hyundai Motor Company, Seoul (KR)

(72) Inventor: Han-Sang Kim, Ansan-Si (KR)

(73) Assignee: Hyundai Motor Company, Seoul (KR)

(21) Appl. No.: 14/095,239

(22) Filed: Dec. 3, 2013

(30) Foreign Application Priority Data
Feb. 22, 2013 (KR) 10-2013-0019430

(51) Int. Cl. F02B 23/10

(52) U.S. Cl. CPC F02B 23/10
USPC 123/294

(57) ABSTRACT

The variable compression engine may include a cylinder formed in a cylinder block, a piston moving upward and downward in the cylinder, a combustion chamber formed by the cylinder and the piston for combusting a fuel-air mixture, a fuel injector configured to inject a fuel into the combustion chamber, an exhaust valve selectively opened to discharge a combustion gas from the combustion chamber, an intake valve selectively opened to supply an intake air into the combustion chamber, an intake manifold that guides the intake air into the cylinder, an air injector configured to suck a gas from the combustion chamber and transfer the gas into the intake manifold, an air passage configured to connect the air injector and the intake manifold so that the gas sucked by the air injector passes therethrough, and a control unit configured to control an operation of the air injector.

### CROSS-REFERENCE TO RELATED APPLICATION

The present application claims priority of Korean Patent Application Number 10-2013-0019430 filed Feb. 22, 2013, the entire contents of which application are incorporated herein for all purposes by this reference.

### BACKGROUND OF INVENTION

1. Field of Invention

The present invention relates to a variable compression engine, and more particularly, to a variable compression engine which obtains an effect of changing a compression ratio by changing pressure of compressed air.

2. Description of Related Art

In general, thermal efficiency of a heat engine is improved as a compression ratio becomes high. Here, the compression ratio refers to a ratio of a volume of air which is compressed in a cylinder by a piston. That is, if a volume of a combustion chamber is changed, the compression ratio is changed.

By changing the compression ratio in accordance with an operational state of an engine, fuel efficiency may be improved in a low load condition of the engine by raising the compression ratio of fuel-air mixture, and the occurrence of knocking may be prevented and engine output may be improved in a high load condition of the engine by lowering the compression ratio of the fuel-air mixture.

In the related art, a variable compression ratio (VCR) apparatus, which changes the compression ratio by changing a top dead center of the piston, has been mainly used.

However, the variable compression ratio apparatus of the related art requires a power source such as a plurality of links, and a motor to change the top dead center of the piston. Therefore, a weight of the engine is increased due to weight of the links and the motor, and a complicated design is required to prevent interference of a plurality of links. In addition, in a case in which it is not easy to change a volume of compressed air, it may be impossible to change the compression ratio.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

The present invention has been made in an effort to provide a variable compression engine which implements an effect of changing a compression ratio even in a case in which it is not easy to change a volume of compressed air.

In addition, the present invention has been made in an effort to provide a variable compression engine which reduces a weight of the engine and simplifies a configuration of the engine.

Various aspects of the present invention provide a variable compression engine, including a cylinder formed in a cylinder block, a piston moving upward and downward in the cylinder, a combustion chamber formed by the cylinder and the piston for combusting a fuel-air mixture, a fuel injector configured to inject a fuel into the combustion chamber, an exhaust valve selectively opened to discharge a combustion gas from the combustion chamber, an intake valve selectively opened to supply an intake air into the combustion chamber, an intake manifold that guides the intake air into the cylinder, an air injector configured to suck a gas from the combustion chamber and transfer the gas into the intake manifold, an air passage configured to connect the air injector and the intake manifold so that the gas sucked by the air injector passes therethrough, and a control unit configured to control an operation of the air injector.

The variable compression engine may further include a cooler disposed in the air passage between the air injector and the intake manifold to cool the gas that passes through the air passage.

The air injector may be an electronic injector which sucks gas in the combustion chamber and injects the gas into the air passage in a short period time. The control unit may be an electronic control unit which controls the air injector.

The air injector may serve as a valve which is selectively opened to transfer the gas in the combustion chamber into the intake manifold. The air injector may be opened so that a pressure in the combustion chamber is lowered in a compression stroke of the engine. The air injector may be opened so that a combustion gas in the combustion chamber is recirculated into the intake manifold in an exhaust stroke of the engine.

The air passage may be a hose made of a heat resistant material. The variable compression engine may further include a cooler provided a cooler to cool a high temperature combustion gas passing through the air passage. The cylinder may include a plurality of cylinders

Various other aspects of the present invention provide a variable compression engine including a plurality of cylinders formed in a cylinder block. Corresponding to each respective cylinder in the plurality of cylinders, a piston moving upward and downward in the cylinder, a combustion chamber formed by the cylinder and the piston for combusting a fuel-air mixture, a fuel injector configured to inject a fuel into the combustion chamber, an exhaust valve selectively opened to discharge a combustion gas from the combustion chamber, an intake valve selectively opened to supply an intake air into the combustion chamber, an intake manifold that guides the intake air into the cylinder, an air injector configured to suck a gas from the combustion chamber and transfer the gas into the intake manifold, an air passage configured to connect the air injector and the intake manifold so that the gas sucked by the air injector passes therethrough. The variable compression engine may also include a control unit configured to control each of the air injectors.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 illustrates a compression stroke of an exemplary variable compression engine according to the present invention.

FIG. 2 illustrates an intake stroke of an exemplary variable compression engine according to the present invention.

FIG. 3 illustrates an exhaust stroke of another exemplary variable compression engine according to the present invention.

FIG. 4 illustrates an intake stroke of another exemplary variable compression engine according to the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

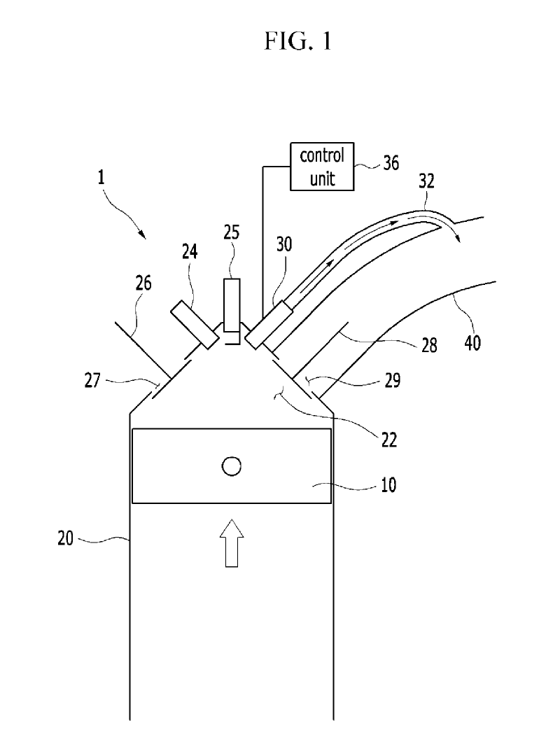

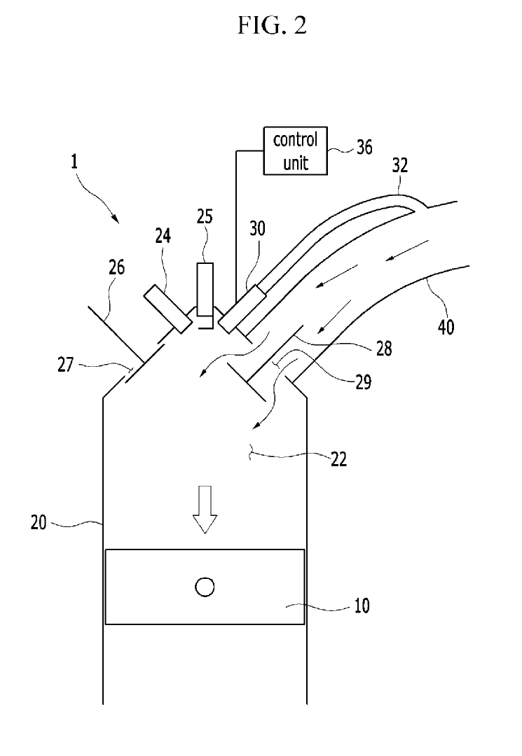

FIG. 1 is a view illustrating a compression stroke of a variable compression engine and FIG. 2 is a view illustrating an intake stroke of the variable compression engine according to various embodiments of the present invention. Meanwhile, in FIGS. 1 and 2, a flow of fuel-air mixture or air, and a movement direction of a piston are depicted by arrows.

As illustrated in FIGS. 1 and 2, a variable compression engine 1 includes a piston 10, a cylinder 20, a combustion chamber 22, a fuel injector 24, a spark plug 25, an exhaust valve 26, an intake valve 28, and an intake manifold 40. In addition, the variable compression engine 1 further includes an air injector 30, an air passage 32, and a control unit 36.

The piston 10 is moved upward and downward in the cylinder 20 formed in any suitable number (e.g. 1, 2, 4, 6, 8, 12) in a cylinder block of the engine 1, and the combustion chamber 22 is formed between the piston 10 and the cylinder 20.

The combustion chamber 22 is enclosed by the piston 10, an inner surface of the cylinder 20, and a cylinder head, and is a space which is formed so that fuel-air mixture is combusted. The fuel injector 24 is a device which injects fuel into the combustion chamber 22. The spark plug 25 is a device which ignites an electric spark in the fuel-air mixture in which fuel injected by the fuel injector 24 and intake air in the engine 1 are mixed.

The exhaust valve 26 is a valve which is opened so as to discharge combustion gas from the combustion chamber 22, or closed so as to allow the combustion chamber 22 to be closed and sealed while the fuel-air mixture or air in the combustion chamber 22 is compressed by an upward movement of the piston 10, and combusted by the electric spark of the spark plug 25.

The intake valve 28 is a valve which is opened so as to supply the fuel-air mixture or air to the combustion chamber 22, or closed so as to allow the combustion chamber 22 to be closed and sealed while the fuel-air mixture or air in the combustion chamber 22 is compressed by the upward movement of the piston 10, and combusted by the electric spark of the spark plug 25.

The intake manifold 40 is a passage which guides the fuel-air mixture or air into each cylinder 20. In addition, the intake manifold 40 is disposed on a lateral surface of the cylinder head, and allows the fuel-air mixture or air to be uniformly distributed into each cylinder 20. Moreover, the intake manifold 40 generates a vortex flow in order to promote the combustion of the fuel-air mixture.

The configuration of the engine including the piston 10, the cylinder 20, the combustion chamber 22, the fuel injector 24, the spark plug 25, the exhaust valve 26, the intake valve 28, and the intake manifold 40 is known in the art, and therefore a more detailed description will be omitted.

The air injector 30 is provided to transfer the fuel-air mixture or air in the combustion chamber 22 into the intake manifold 40. In addition, the air passage 32 is a passage which connects the air injector 30 and the intake manifold 40. That is, the air injector 30 transfers the fuel-air mixture or air in the combustion chamber 22 into the air passage 32, and the fuel-air mixture or air transferred into the air passage 32 is transferred into the intake manifold 40 through the air passage 32.

The air injector 30 may be an electronic injector which injects the fuel-air mixture or air in the combustion chamber 22 into the air passage 32 so that the fuel-air mixture or air in the combustion chamber 22 is transferred into the intake manifold 40 in a short period of time. In addition, the air injector 30 serves as a valve which is selectively opened when the fuel-air mixture or air is transferred into the intake manifold 40. Moreover, when the air injector 30 is opened, the fuel-air mixture or air in the combustion chamber 22 is supplied to the air injector 30 by pressure in the combustion chamber 22. Therefore, the injection of the fuel-air mixture or air by the air injector 30 may be performed.

Meanwhile, as the air injector 30 is connected to the intake manifold 40, the fuel-air mixture or air sucked from the combustion chamber 22 is supplied again to the combustion chamber 22 through an intake port 29, and only a hole is formed in the cylinder head where the air injector 30 is mounted, but a separate hole for supplying the fuel-air mixture or air again to the combustion chamber 22 is not required.

The control unit 36 determines an opening timing and an opening time period of the air injector 30, and controls an operation of the air injector 30. In addition, the control unit 36 may be a typical electronic control unit (ECU) which generally controls electronic devices of a vehicle. Moreover, the control unit 36 determines the opening timing and the opening time period of the air injector 30 in accordance with an operational state of the engine 1 based on a database constructed in advance, and operates the air injector 30. Here, the operational state of the engine 1 refers to a rotation speed, a load, and the like of the engine 1, and the control unit 36 continuously performs a mapping operation on the operational state of the engine 1 and the operation of the air injector 30, thereby allowing the database to be updated.

By the opening operation of the air injector 30, an effect may be obtained in which pressure in the combustion chamber 22 becomes low, and a compression ratio becomes low. In addition, the variable compression engine 1 is basically designed to have a high compression ratio, and adjusts pressure in the combustion chamber 22 in accordance with the operation of the air injector 30.

When the piston 10 is moved upward in accordance with a compression stroke of the variable compression engine 1, as illustrated in FIG. 1, the air injector 30 is opened. That is, the combustion chamber 22 and the intake manifold 40 are communicated with each other through the air passage 32. In addition, the air injector 30 sucks the fuel-air mixture or air in the combustion chamber 22 and injects the fuel-air mixture or air into the air passage 32 so that the fuel-air mixture or air in the combustion chamber 22 is rapidly supplied into the intake manifold 40. Meanwhile, as negative pressure is formed in the intake manifold 40 during the compression stroke of the variable compression engine 1, the fuel-air mixture or air injected into the air passage 32 is naturally or readily transferred into the intake manifold 40. Moreover, the air injector 30 is opened at a predetermined timing and for a predetermined period of time, and then closed.

In the compression stroke, the timing and the time period when the air injector 30 is opened are set to be before the piston 10 reaches a top dead center. For example, the timing when the air injector 30 is opened during the compression stroke may be set within a range of a crank angle of 0° to −30° based on the top dead center of the piston 10. In addition, the time period when the air injector 30 is opened may be a time period when the crank angle is changed by 10° within the range of the crank angle. That is, the time period when the air injector 30 is opened is set based on an amount of change in crank angle, and is varied in accordance with a rotation speed of the engine 1. Here, pressure of compressed air is maintained to be 10 bar to 15 bar even if the pressure of the compressed air becomes low.

As described above, as the air injector 30 is opened, an amount of air in the combustion chamber 22 is reduced, and air pressure in the combustion chamber 22 is lowered. As the variable compression engine 1 is operated during this compression stroke, an effect may be obtained in which a compression ratio is lowered.

When the piston 10 is moved downward in accordance with an intake stroke of the variable compression engine 1, as illustrated in FIG. 2, the intake valve 28 is opened in a state in which the air injector 30 is closed. That is, the combustion chamber 22 and the intake manifold 40 are communicated with each other through the intake port 29 which is selectively opened or closed by the intake valve 28. In addition, the fuel-air mixture or air in the intake manifold 40 is supplied into the combustion chamber 22. That is, the fuel-air mixture or air, which is supplied into the intake manifold 40 through the air passage 32 in the compression stroke of the variable compression engine 1, is supplied into the combustion chamber 22 together with intake air.

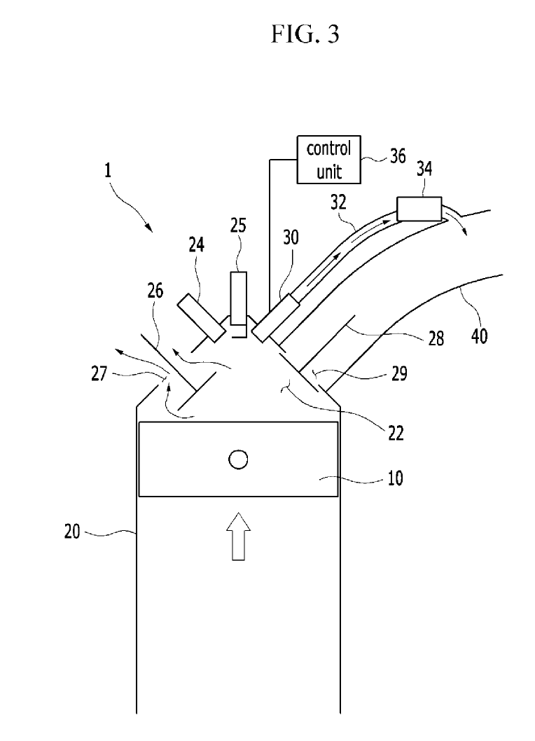

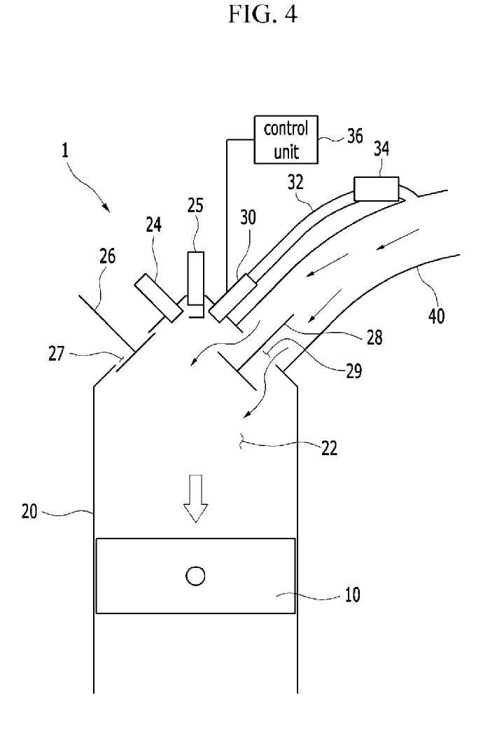

FIG. 3 is a view illustrating an exhaust stroke of a variable compression engine and FIG. 4 is a view illustrating an intake stroke of the variable compression engine according to various embodiments of the present invention. Meanwhile, in FIGS. 3 and 4, a flow of fuel-air mixture or air, and a movement direction of a piston are depicted by arrows.

As illustrated in FIGS. 3 and 4, a variable compression engine 1 according to various embodiments of the present invention includes a cooler 34. Meanwhile, other constituent elements of the variable compression engine 1 according to various embodiments of the present invention, except for the cooler 34, are similar to substantially the same as those described above with reference to FIGS. 1 and 2. Therefore, description regarding such similar or substantially the same elements will be omitted.

The cooler 34 is provided to cool high temperature fuel-air mixture or air. In addition, the cooler 34 is disposed between the air injector 30 and the intake manifold 40 so that the fuel-air mixture or air passes through the air passage 32 via the cooler 34. That is, the cooler 34 cools the fuel-air mixture or air injected from the combustion chamber 22 by the air injector 30.

When the piston 10 is moved upward in accordance with an exhaust stroke of the variable compression engine 1, as illustrated in FIG. 3, the exhaust valve 26 and the air injector 30 are opened. That is, combustion gas in the combustion chamber 22 is discharged through an exhaust port 27 of the combustion chamber 22, which is selectively opened or closed by the exhaust valve 26, and the combustion chamber 22 and the intake manifold 40 are communicated with each other through the air passage 32. In addition, the air injector 30 sucks the combustion gas in the combustion chamber 22 and injects the combustion gas into the air passage 32 so that the combustion gas in the combustion chamber 22 is rapidly supplied into the intake manifold 40. Meanwhile, as negative pressure is formed in the intake manifold 40 during the exhaust stroke of the variable compression engine 1, the combustion gas injected into the air passage 32 is naturally or readily transferred into the intake manifold 40. At this time, the combustion gas injected into the air passage 32 is transferred into the intake manifold 40 after being cooled by passing through the cooler 34.

During this exhaust stroke, exhaust gas recirculation (EGR) may be performed in accordance with an operation of the variable compression engine 1. Here, the fuel-air mixture or air injected from the combustion chamber 22 may have a high temperature of 100° C. to 200° C. If the high temperature fuel-air mixture or air is supplied into the intake manifold 40 without being cooled, efficiency of the exhaust gas recirculation may deteriorate. Therefore, the cooling by the cooler 34 serves to improve efficiency of the exhaust gas recirculation. Meanwhile, the air passage 32 may be a hose made of a heat resistant material so as to endure a high temperature. Here, the hose refers to a flexible pipe formed of rubber or fabric.

The air injector 30 is opened for a predetermined period of time, and then closed. In the exhaust stroke, the timing and the time period when the air injector 30 is opened are set to be before the piston 10 reaches a top dead center. For example, the timing when the air injector 30 is opened during the exhaust stroke may be set within a range of a crank angle of −90° to −180° based on the top dead center of the piston 10. In addition, the time period when the air injector 30 is opened may be a time period when the crank angle is changed by 10° within the range of the crank angle. That is, the time period when the air injector 30 is opened is set based on an amount of change in crank angle, and is varied in accordance with a rotation speed of the engine 1. Meanwhile, the time period when the air injector 30 is opened may be different from the time period when the exhaust valve 26 is opened.

The intake stroke of the variable compression engine 1, which is illustrated in FIG. 4, is substantially the same as the intake stroke of the variable compression engine 1, which is illustrated in FIG. 2, in terms of an operation of the variable compression engine 1, except that the cooler 34 is provided, and therefore a repeated description will be omitted.

Meanwhile, the operation of the variable compression engine 1 according to various embodiments of the present invention in the compression stroke is substantially the same as the operation described above with reference to FIG. 1, except that the fuel-air mixture or air injected from the combustion chamber 22 passes through the cooler 34.

The variable compression engine 1 of the present invention may obtain an effect of changing a compression ratio by changing an amount of air which is compressed in the combustion chamber 22, in a case in which it is not easy to change a volume of the combustion chamber 22.

As described above, according to the present invention, as the configuration of the engine 1 is simplified and a weight of the engine 1 is reduced, fuel efficiency of a vehicle may be improved. In addition, continuous variable compression is possible without changing a volume of compressed air by controlling an amount of air in the combustion chamber 22. Moreover, exhaust gas recirculation may be performed by moving air in the combustion chamber 22 into the intake manifold 40 during the exhaust stroke.

For convenience in explanation and accurate definition in the appended claims, the terms “upward” or “downward”, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A variable compression engine, comprising:
a cylinder formed in a cylinder block;
a piston moving upward and downward in the cylinder;
a combustion chamber formed by the cylinder and the piston for combusting a fuel-air mixture;
a fuel injector configured to inject a fuel into the combustion chamber;
an exhaust valve selectively opened to discharge a combustion gas from the combustion chamber;
an intake valve selectively opened to supply an intake air into the combustion chamber;
an intake manifold that guides the intake air into the cylinder;
an air injector configured to suck a gas from the combustion chamber and transfer the gas into the intake manifold;
an air passage configured to connect the air injector and the intake manifold so that the gas sucked by the air injector passes therethrough; and
a control unit configured to control an operation of the air injector.

2. The variable compression engine of claim 1, further comprising a cooler disposed in the air passage between the air injector and the intake manifold to cool the gas that passes through the air passage.

3. The variable compression engine of claim 1, wherein the air injector is an electronic injector which sucks gas in the combustion chamber and injects the gas into the air passage in a short period time.

4. The variable compression engine of claim 3, wherein the control unit is an electronic control unit which controls the air injector.

5. The variable compression engine of claim 1, wherein the air injector serves as a valve which is selectively opened to transfer the gas in the combustion chamber into the intake manifold.

6. The variable compression engine of claim 5, wherein the air injector is opened so that a pressure in the combustion chamber is lowered in a compression stroke of the engine.

7. The variable compression engine of claim 5, wherein the air injector is opened so that a combustion gas in the combustion chamber is recirculated into the intake manifold in an exhaust stroke of the engine.

8. The variable compression engine of claim 7, wherein the air passage is a hose made of a heat resistant material.

9. The variable compression engine of claim 7, further comprising a cooler to cool a high temperature combustion gas passing through the air passage.

10. The variable compression engine of claim 1, wherein the cylinder comprises a plurality of cylinders.

11. A variable compression engine, comprising:
(A) a plurality of cylinders formed in a cylinder block;
(B) corresponding to each respective cylinder in the plurality of cylinders:
(i) a piston moving upward and downward in the cylinder;
(ii) a combustion chamber formed by the cylinder and the piston for combusting a fuel-air mixture;
(iii) a fuel injector configured to inject a fuel into the combustion chamber;
(iv) an exhaust valve selectively opened to discharge a combustion gas from the combustion chamber;
(v) an intake valve selectively opened to supply an intake air into the combustion chamber;
(vi) an intake manifold that guides the intake air into the cylinder;
(vii) an air injector configured to suck a gas from the combustion chamber and transfer the gas into the intake manifold; and
(viii) an air passage configured to connect the air injector and the intake manifold so that the gas sucked by the air injector passes therethrough; and
(C) a control unit configured to control each of the air injectors.
